(19) United States
(12) Patent Application Publication
(10) Pub. No.: US 2005/0165683 A1
(43) Pub. Date: Jul. 28, 2005

(54) System and method for using a universal payment card for transportation vehicles for hire

(76) Inventor: Acquenetta Taylor, Chicago, IL (US)

Correspondence Address: JoAnne M. Denison;DENISON & ASSOC., PC, Suite 2004, 212 W. Washington Blvd., Chicago, IL, 60606, US

(21) Appl. No.: 10/756,665

(22) Filed: Jan. 13, 2004

(51) Int. Cl. G06F 17/60

(52) U.S. Cl. 705/44

(57) ABSTRACT

The present invention comprises a payment debit system specifically tailored to transportation vehicles and the method for its use wherein a passenger preferably will pre-purchase a card for a predetermined amount of fare at local outlets to be used in any hired vehicle located throughout the world equipped with the system. A second preferred embodiment will allow the passenger to swipe the card into a computer terminal located within a transportation vehicle, thus allowing a passenger to choose her or his destination and fare, upon which occurrence terminal connects to a main computer database after pin confirmation via satellite, thereby deducting the amount of fare from the debit card and printing a confirmation receipt for the passenger. A third preferred embodiment of the present invention includes a panic device akin to LoJack® system for security purposes that may be depressed by both a driver and/or a passenger in case of emergency.

This application claims benefit of U.S. provisional application Ser. No. 60/425,989, filed on Jan. 13, 2003.

### FIELD OF THE INVENTION

The present invention relates to the field of transportation payment systems and methods, and more particularly to a transportation payment system utilizing a prepaid, personalized debit card with pin number and tracking capabilities, thereby eliminating the necessity of paying drivers with paper or coin currency, and allowing passengers to safely request and reach a particular destination of their choosing.

### BACKGROUND OF THE INVENTION

Many people prefer to use chauffeured or hired transportation vehicles in general, and taxi cobs in particular, to travel within cities and other municipalities. In the interest of avoiding parking under unfavorable and often expensive conditions as well as avoiding the inherently hectic traffic in urban locations, passengers request cobs, limos, vans and other non mass transit vehicles to take them to particular destinations, thereby avoiding the hassle of waiting for public transportation. After a passenger has been driven to the desired location, the passenger will generally pay the fare using paper currency or their coin counterparts. Unfortunately, this places the drivers at the risk of carrying large amounts of cash currency, making them vulnerable to thieves intent on robbing and perhaps even injuring these drivers with the use of dangerous weapons. It may also place the drivers in the intolerable position of believing they must racially profile potential passengers in order to avoid such injury. Passengers also may find it inconvenient to pay in cash currency and they often have heated disputes with the driver of the vehicle over what they consider to be excessive fees or the extraordinary route taken.

Currently, in the marketplace, there are available a wide variety of devices and systems which allow passengers of hired transportation vehicles such as cobs, limos, vans and the like, to avoid paying fares with paper or coin currency, and they also prevent harm or injury to taxi drivers as well as other vehicle chauffeurs. Such prior art systems, however, fail to simplify the payment system for average passengers and do not allow passengers to control the journey and price of the ride. The present invention avoids the problems associated with prior art transportation payment and destination systems by allowing passengers to purchase prepaid taxi or cab service cords at local grocery stores and other retail outlets, similar to the prepaid calling cards commonly available in the marketplace. The passenger would also have the right to pick the least costly or perhaps most direct route to a destination while riding. The driver in turn would feel secure in knowing that the ride will be paid for by the passenger.

In reviewing the prior art, there are numerous patent disclosures that provide passengers the method or system to avoid the usage of paper currency for transportation payments. Many of these systems and devices have found ways for riders to pay with credit cards at the time of riding or with debit cards prior to dispatch. But none seemingly allow passengers to prepay for a larger amount of cab rides, nor do they provide the passenger with the ability to choose the route of the journey and control the fore.

For example, U.S. Pat. No. 5,973,619 discloses an automatic dispatch and payment honoring system which is virtually a computerized taxi stand. The disclosed system allows passengers to choose the taxi company, the destination and pay the fare in advance using either a credit cord or a TAXILINK card. The passenger then receives a payment voucher after the system communicates with a main computer which dispatches the taxi to the location of the passenger. This system targets prepaid taxi service but it does not disclose an on board cob fare payment system where any passenger can pay for the cab service simply by swiping a card. Nor can the passenger control the route for reaching the destination under this patented disclosure. Moreover, if the payment voucher of the disclosed system is stolen or lost, a replacement plan is not provided for.

Further, U.S. Patent Application No. 2003/0078793 discloses an enhanced customer-centric restaurant meal ordering system which allows the user to access a virtual server which describes dishes on a menu, preparation style, and allows the user to order and pay for a meal automatically. While this application disclosure does provide for a system that allows for on-site payment, it is only directed to restaurant services and it fails to utilize a prepaid debit card. It only allows for making payments via commonly utilized methods including cash currency, credit card and gift certificates, a concept that the present invention is not primarily concerned with.

U.S. Pat. No. 6,543,689 discloses a credit card and bar code reader module which is adapted to communicate with an existing pager to enable the reading of a card having a magnetic strip via wireless mechanisms. While this device is directed for use on printers and taxi fare meters, it does not utilize a specific transportation prepaid purchase card system which allows the passenger to control the fare and route to the destination and prepay for the ride itself.

Similarly, U.S. Pat. No. 6,347,739 discloses an on board payment system for taxicabs which allows for payment by credit or debit cards via wireless modem. Basically, the system communicates with a proxy internet server and it utilizes the possenger's own credit card or personal bank card. But this device once again fails to allow a passenger to control payment in advance of the actual ride and it does not allow the passenger the ability to decide what route to take to the destination of choice. The risks associated with loss of the credit or debit card used are high to the passenger, whereas the present invention allows the passenger to minimize risk through a pin number and tracking system.

U.S. Pat. No. 6,289,315 also discloses a credit card swipe system. The system allows for voice identification in possenger's chosen language and allows for payment in any foreign or domestic currency of choice. Once again, this system fails to allow passengers to choose the route taken or to pay for a large number of cab rides in advance of hiring a vehicle.

U.S. Pat. No. 5,991,410 discloses a wireless adapter and wireless financial transaction system that automatically encrypts and decrypts financial data, thereby allowing mobile businesses such as taxicabs and the like to accept credit cards and debit cards without requiring dial-up authorization. This device and system does not disclose an on-site authorization device based on a prepaid transportation card.

U.S. Pat. No. 4,552,385 discloses a multilayer identification code which is equipped with an IC module which is secured with a hot layer lamination technique and does not disclose any system which refers or related to transportation debit card systems. U.S. Pat. No. 5,166,501 discloses a financial transaction card which includes a tagging element which is to be used by electronic article surveillance systems during the manufacture of an item or prior to issue to prevent unauthorized use of credit cards after manufacture. U.S. Pat. No. 5,688,738 issued to Lu discloses the use of a security card and its laminated configuration. Neither of the lost two aforementioned disclosures teaches or hints at anything related to prepaid transportation debit cards.

Therefore, it can be appreciated that there is a significant need for a prepaid debit card system in which passengers may not only universally pay for the use of a hired vehicle without cash currency, but also may track and control the route of their journey, resulting in greater economy and flexibility to the consumer.

### SUMMARY OF THE INVENTION

The present invention is directed to a system for prepaid transportation debit cards and the method of using the some, akin to a prepaid calling card, to make a passenger's on board transportation payment while controlling the destination, route, and consequently the fare of the ride. The system in the present invention departs from the prior art in that it allows the passenger to purchase several transportation rides in advance of travel and in round dollar increments, ($10, $25, $50, etc.) at local grocery stores, drug stores and other retail outlets that a customer is likely to visit several times a week. The passenger may also contact the main computer database at a later time to use a credit card to replenish the fare amount on the existing prepaid transportation debit card. This may be accomplished via the internet, email, fax, phone or mail. Computer driven systems may fully automate the replenishment of fare value when the internet or the phone is utilized by the card owner.

The present invention allows the passenger to swipe a universal payment card to pay for any hired vehicle ride. The card is preferably a magnetically coded card made of hard plastic with raised letters and/or numbers, and it will be approximately the size of a credit cord. It will further have a unique card code assigned to it which identifies a unique number for the card, an expiration date, if any, a pin number that only the user of the card will be aware of and as is imprinted on a sticker that is secured to the card at time of card activation or purchase. The card preferably will further be provided with a space for the user to write in her or his name and contact number in the event that the card is lost or stolen.

The present invention allows the passenger to swipe the prepaid cord into a terminal with GPS Navigational System circuitry, information display means, including an LCD screen or plasma screen, touch screen or its equivalent which is preferably equipped with a security panic button akin to LoJack® or its equivalent. LoJack® is more fully disclosed by U.S. Pat. No. 6,246,323 which is herewith incorporated by reference, provides for a method and system for tracking a vehicle. U.S. Pat. No. 6,317,049 discloses an apparatus and method for locating missing persons, animals and objects and the like may also be a possible device used to provide security, and is incorporated by reference herewith.

After swiping the vehicle payment card, the passenger will be prompted to enter his or her destination on the keypad. The passenger will then be directed to pick the route and thus fare of his or her choice, whether it is the “most expedient” or the one with the “least mileage”. The “most expedient” route is the one using the path that will take least amount time, but may require the usage of highways that may increase the mileage. The passenger can also choose the “least mileage” route which will be the shortest route in terms of distance but perhaps not time. The driver may choose to take a different route, but the passenger's choice rules in terms of fare deducted from the card. After choosing the destination and route, the passenger will enter the number of passengers and pieces of luggage. However, the passenger will then be requested to include a tip for the ride that may also be deducted from the cord, or the passenger can wait until the end of the ride to tip, or at anytime in between by simply depressing the “tip” key. The passenger will next be prompted to enter the pin number. If the pin number is invalid, there will be another prompt to reenter valid pin. After three such invalid entries, the card will void itself. Once the pin number is entered validly, the customer will be prompted to confirm the destination and the fare amount. After this confirmation, this information will be systematically sent to a central computer database via satellite, which will keep track of the usage of the cord, its loss or stolen status, and deduct from the original purchase amount the fare for the route chosen. The central computer will respond in due course back to terminal. A confirmation receipt will print at the end of the ride for passenger's benefit. If the card is lost or stolen, the computer will not allow for payment through the card for twenty four hours after being reported stolen or lost.

### OBJECTS OF THE INVENTION

It is a primary object of the present invention to utilize a payment debit system specifically tailored to hired transportation vehicles, by providing a prepaid debit card, to prevent drivers and passengers from taking the risk of handling large amounts of cash currency.

Another primary object of the present invention is to utilize a payment debit system specifically tailored to hired transportation vehicles having a card swiping device for the prepaid card, in order to allow any passenger to use a universal prepaid card to access a main computer database.

An additional primary object of the present invention is to utilize a payment debit system specifically tailored to hired transportation vehicles by providing an on board terminal with touch screen, LCD or plasma display in the vehicle, in order to allow the passenger easy access to the system.

Another primary object of the present invention is to utilize a payment debit system specifically tailored to hired transportation vehicles by providing an on board terminal with keypad, allowing the passenger to dictate the location and fare for the destination of choice.

An additional primary object of the present invention is to utilize a payment debit system specifically tailored to hired transportation vehicles by providing an on board terminal with access to a GPS navigational system, such that passengers may experience cost effective rides to the destinations of their choice thereby avoiding heated arguments over fare and also eliminating misinformation regarding the destination.

Another primary object of the present invention is to utilize a payment debit system specifically tailored to hired transportation vehicles which is provided with a wireless satellite transferring device that communicates with an on-board terminal for the purpose of communicating data from an on-board terminal to a main computer database, enabling speedy debiting.

An additional primary object of the present invention is to utilize a payment debit system specifically tailored to hired transportation vehicles having a terminal with an internal printer to print confirmation receipt of debit deduction and destination choice.

Another primary object of the present invention is to utilize a payment debit system specifically tailored to hired transportation vehicles which is provided with an on board terminal equipped with a security panic device akin to LoJack® or its equivalent enabling the main computer database to notify authorities in emergency situations to ensure the safety of both the drivers and passengers of equipped vehicles.

An additional primary object of the present invention is to utilize a payment debit system specifically tailored to hired transportation vehicles which is provided with a main computer database that tracks whether or not the prepaid debit card is lost or stolen, to ensure that passengers will not worry about the loss of their universal transportation payment cards and drivers will not have to incur the cost of such a loss or theft.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 shows the front perspective view of a sample embodiment of a universal transportation payment card for prepaid transportation payments and services.

FIG. 2 shows a back perspective view of a sample embodiment of a universal transportation payment card for prepaid transportation payments and services.

FIG. 3 shows a front perspective view of a sample embodiment of the swiping terminal with LCD display, GPS Navigational System, number and letter keypad, and possible panic button device akin to LoJack® emergency systems.

FIG. 4 shows a flowchart of the method of using the system, as executed by passenger, a universal payment transportation card, a swiping terminal, and a main computer database.

FIG. 5 shows a sample embodiment of the software modules for swiping terminal shown in FIG. 3.

### DETAILED DESCRIPTION OF THE DRAWINGS

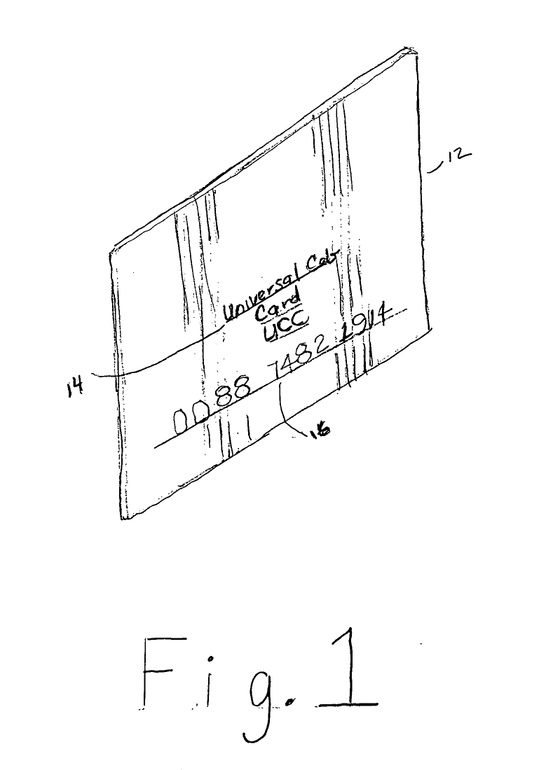

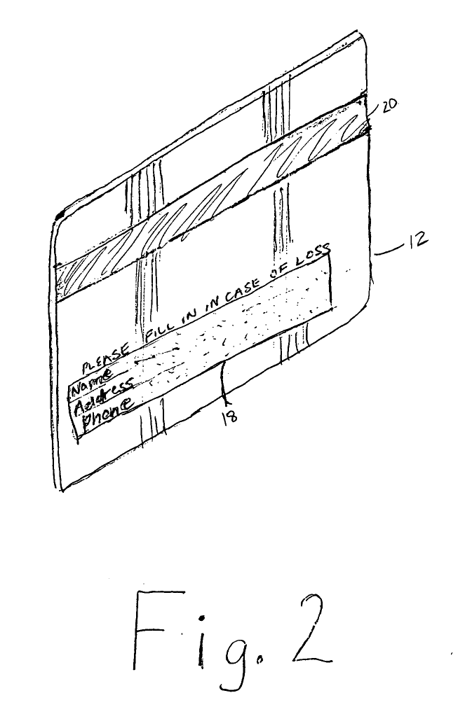

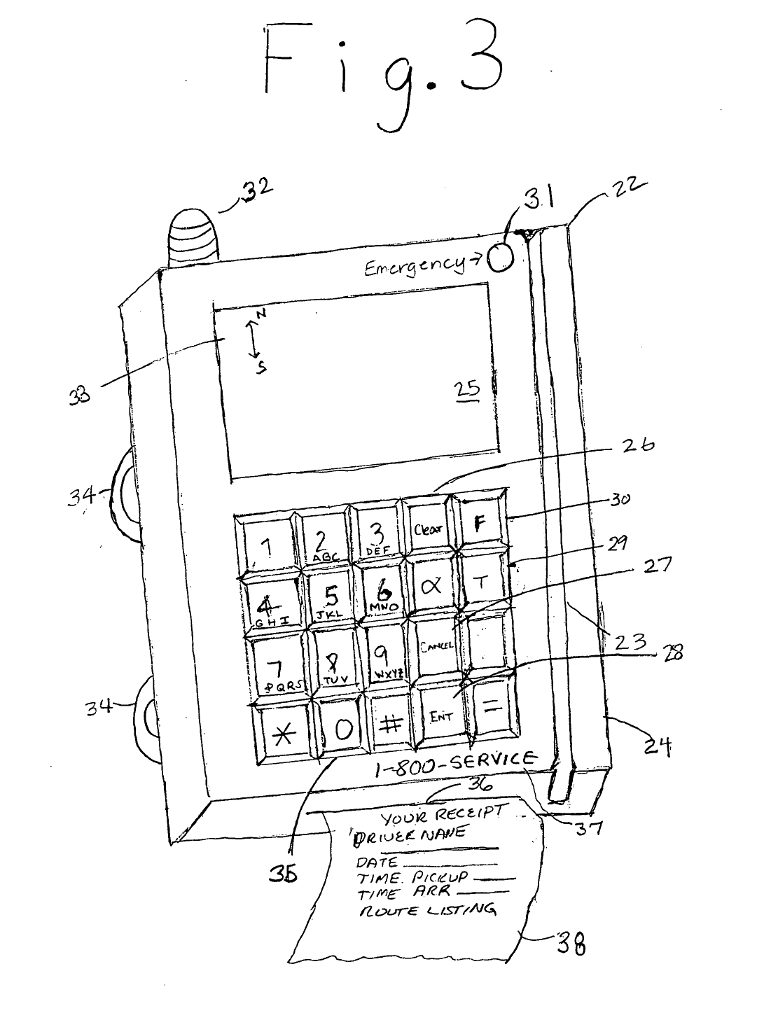

Shown now in FIG. 1 is a sample embodiment of prepaid transportation system card 12, which is intended for use with the present inventive prepaid transportation payment system. The prepaid transportation system card 12 resembles a typical credit card, complete with the name, trade name, trade mark or service mark of the card placed in the middle of the card 14. Raised numbers 16, unique to the prepaid transportation system card, are provided as demonstrated on the bottom of the prepaid transportation system card 12, while available writing space 18, which is preferably white in color, is provided on the back of prepaid transportation system card 12 which allows the name, phone and address of the card owner to be written in the space as shown in FIG. 2. Although the prepaid transportation system card 12 is made from hard, shiny plastic, or other copolymer, available writing space 18 has been coated with a writing implement coating as shown so that when the owner of prepaid transportation system card 12 writes in available writing space 18, the graphite from a pencil or the ink of a pen with be readily absorbed and retained thereupon. The magnetic strip 20 on the back of the card as shown in FIG. 2 will both store and transfer the data from the card 12 to terminal 22 shown in FIG. 3. Both the coating on the back of the card and the magnetic strip are features commonly used and readily available in the current marketplace.

The card swiping terminal to be installed into each desired vehicle is shown in FIG. 3 as terminal 22. The terminal 22 of FIG. 3 will preferably be approximately 5.75 inches in width and 6 inches in length, although other dimensions may be used as desired, and will be attached to the vehicle's back seat using wires, adhesive, common fasteners, or other affixation methods commonly available in the marketplace. In this particular instance, a set of coated wires 34, have been provided along the periphery of the opposing side portions of terminal 22. Swiping slot 23 is also provided for the card holder to swipe the card therethrough, a procedure which is commonly known in the marketplace to consumers. The viewing LCD, touch screen, or plasma screen 25 will communicate with circuitry for a GPS Navigational system 33, and is contained in housing 24 of terminal 22. The left hand side of the terminal directly beneath and adjacent to the touch screen, LCD or plasma screen 25 will have a keypad 35 including the number system used on a regular telephone. Vertically adjacent to the number system on the keypad 35, there will be a button for clear 26, cancel 27 and enter 28. Vertically adjacent to those buttons on the keypad 35, there will be a button to see the fare at any given time during the ride 30, and another button to add tip 29. There will be an emergency button 31 at the very top right hand corner adjacent to swiping slot 23. There will be a display of the customer service number 37 under both the number system and the adjacent counterparts that may be called if the system is not functioning properly or if there is a fare dispute. The data from the terminal 22 will be transferred via satellite through the antenna 32 which is provided on the exterior of housing 24 of terminal 22. This procedure is commonly known in the art relevant to credit and debit card swiping devices. The receipt 38 will print from the internal printer 36, shown at the bottom of terminal 22. The receipt 38 preferably lists pertinent information from the trip, such as cob number, driver name, date, time of pick up, time at destination, and then the details of the route, listing streets and mileage on each street, in the event there is a later dispute.

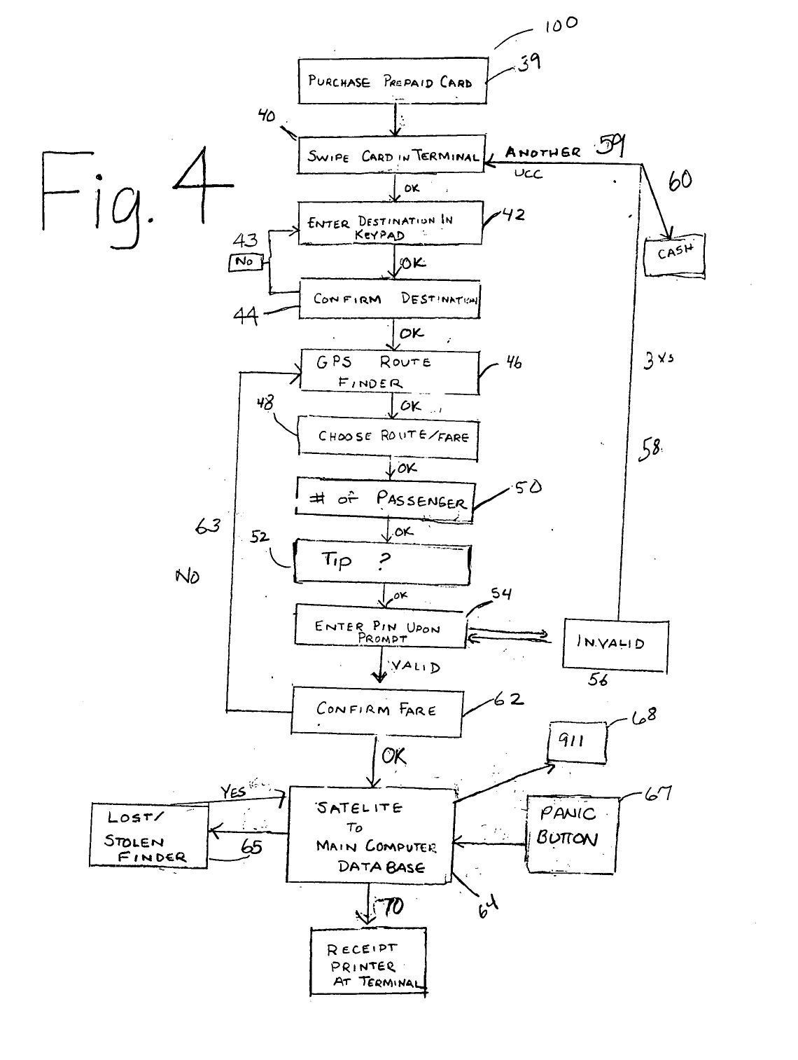

FIG. 4 shows the detailed flowchart 100 of the method for using the present invention. First, the passenger must purchase a universal prepaid transportation card at an earlier time 39. Upon entering a vehicle equipped with the system, the passenger will swipe the card in terminal 40. Upon prompt, the passenger will enter the destination 42 using keypad 35 shown in FIG. 3. The passenger will then confirm destination 44 upon prompt from LCD or plasma screen shown in FIG. 3 as 26 or decline 43 at which point the passenger will have to reenter the destination 42. After the passenger confirms the destination, the GPS System will find routes 46. The passenger must then choose the route and its matching fare 48. The passenger will then enter in the number of passengers 50 into keypad 35 as shown in FIG. 3. The passenger can then choose upon prompt to enter a tip 52 into keypad 35 or can wait until later to enter tip. The passenger then will be prompted to enter pin 54. If the passenger enters an invalid pin 56, the passenger will be required to enter the pin once again 54. After three such attempts, the card will be invalidated 58. Upon invalidation, the passenger may choose to swipe another prepaid transportation card 59 or pay with another method 60. If the passenger enters in a valid pin, the passenger will be required to confirm the fare 62. If the passenger does not confirm the fare 63, the passenger will have to reenter the GPS Route Finder 46. If the passenger confirms the fare, the information will be sent to the main computer database 64 through the wireless satellite device 30 as shown in FIG. 3. The main computer database will determine if the cord was lost or stolen 65. If the card was lost or stolen in the past 24 hours, the passenger will receive a receipt to printer of terminal 70 denying service. If the card was not stolen, the amount of the fare along with tip will be deducted and the passenger will receive a receipt to printer of terminal 70. If either driver or passenger depresses panic device button 31, the main computer will be informed 67 and will call 911 or another appropriate emergency number for the area that the cob is driving within 68.

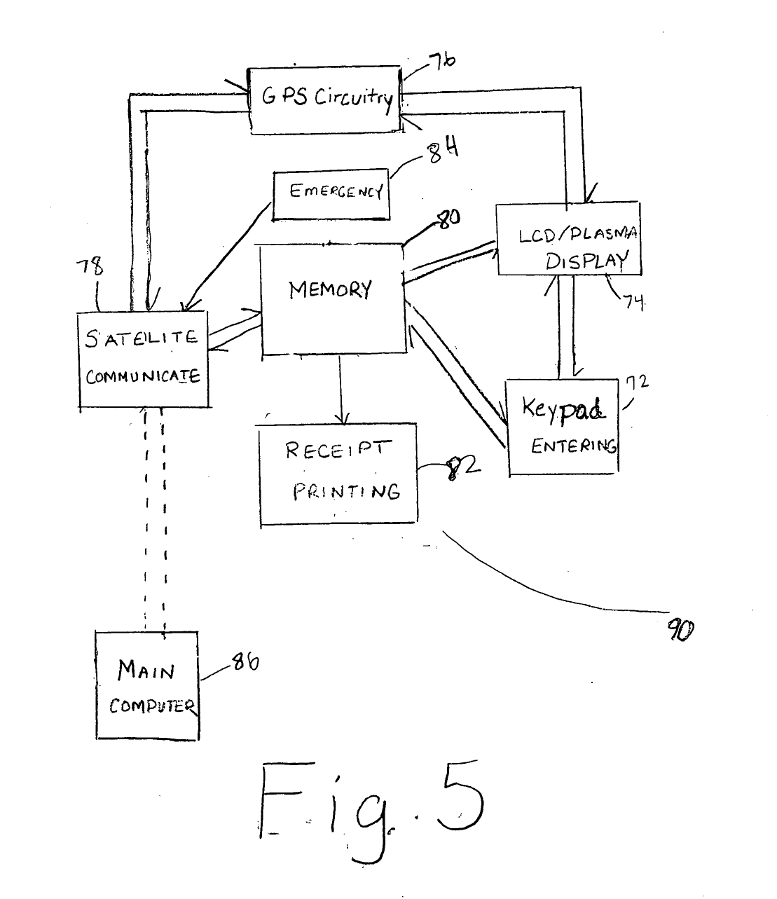

FIG. 5 shows the circuit diagram 90 showing the communication between software modules for the on-board computer terminal 22 shown in FIG. 3. In order to run the terminal, there is a module for keypad entering 72 that would communicate the information keyed into keypad to the memory 80 and to the touchscreen, LCD or plasma display software 74. The display software 74 communicates with the software for the GPS circuitry 76, which in turn communicates to the wireless satellite communication software 78 the destination of passenger's choice. The display software 74 also communicates with the memory 80. The satellite module 78 communicates with the outside main computer 86 via wireless mechanism to record the routes and determine fare. The figure also shows how the main computer communicates data back to satellite 78 which communicates with the memory 80 for receipt printing 82 or back to the keypad 72 if more data is required from the passenger. The emergency button when depressed will be communicated via the emergency module 84 located within the terminal sent to the main computer 86 via the satellite communication software 78.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

1. A system for payment of hired transportation comprising:
a prepaid transportation debit card;
a computer terminal affixed to a transportation vehicle capable of calculating the fare and routes for a particular passenger destination;
a swiping device as attached to the computer terminal able to communicate information on card to computer terminal;
a wireless satellite circuitry affixed to computer terminal communicating information from computer terminal to main computer database; and
a main computer database that deducts the fare from the prepaid transportation debit card and tracks card use.

2. The system in claim 1 wherein the prepaid transportation debit card is further provided with a pin number.

3. The system in claim 1 wherein the prepaid transportation debit card is further made of a substantially rigid copolymeric substance.

4. The system in claim 1 wherein the computer terminal is further provided with a display of one of the following types: touchscreen, LCD or plasma.

5. The system in claim 1 wherein the computer terminal is further provided with circuitry for a GPS navigational system.

6. The system in claim 1 wherein the computer terminal is further provided with a keypad.

7. The system in claim 1 wherein the computer terminal is further provided with an internal printer with external receiving device.

8. The system in claim 1 wherein the computer terminal is further provided with a panic button for security purposes.

9. The system in claim 7 wherein the panic button for security purposes is a LoJack® system.

10. The system in claim 1 wherein the swiping device is substantially the width of the prepaid transportation card.

11. The system in claim 1 wherein the main computer database confirms lost or stolen status.

12. The system in claim 1 wherein the main computer database can communicate with external emergency services.

13. The system in claim 1 wherein the main computer database can communicate with a credit card for expedient fare replenishment to the debit card.

14. A method of passenger effectuating payment for hired transportation comprising the steps of:
a) providing a prepaid transportation debit card in a predetermined amount;
b) swiping a prepaid transportation debit card into a computer terminal attached to transportation vehicle.
c) entering destination data into a computer terminal;
d) choosing a route utilizing the computer terminal;
e) entering in a predetermined pin number;
f) communicating destination, fare, and pin information via satellite to main computer database; and
g) receiving confirmation data regarding debit deduction and destination.

15. The method in claim 14 wherein the passenger can enter in a tip to the terminal for fore deduction.

16. The method in claim 14 wherein the passenger can enter in the number of passengers into the terminal.

17. The method in claim 16 wherein the passenger will invalidate a prepaid transportation card after three failed attempts in entering an incorrect pin.
